(19) United States
(12) Patent Application Publication
(10) Pub. No.: US 2002/0082898 A1
(43) Pub. Date: Jun. 27, 2002

(54) Radiological image management system configuration and selection method and apparatus

(76) Inventor: Edward J. Panelli, Chicago, IL (US)

Correspondence Address: Patrick S. Yoder, Suite 330, 7915 FM 1960 West, Houston, TX, 77070, US

(21) Appl. No.: 09/746,969

(22) Filed: Dec. 22, 2000

(51) Int. Cl. G06F 17/60

(52) U.S. Cl. 705/10

(57) ABSTRACT

A system and method for providing a radiological viewing station system customer with a recommended radiological viewing station and/or radiological viewing station configuration. The recommended radiological viewing station being established by a customer's responses to a plurality of questions. The system has a product selector file and a product configuration file. The product selector file provides a query page with the plurality of questions to be answered by the customer. The product configuration file having a plurality of predicted system values. A Java applet being used to compare the customer's responses to the plurality of questions to the predicted values. The product configuration file supplying a results page with the recommended system.

### FIELD OF THE INVENTION

The present invention relates generally to a method and apparatus for providing purchasing information to a radiological viewing station customer, and more particularly, to a method and apparatus to enable a radiological viewing station supplier to provide a customer with a recommended radiological viewing station.

### BACKGROUND OF THE INVENTION

Historically, medical diagnostic images were recorded by exposing an imaging plate to a source of penetrating radiation. To view the image on the imaging plate, the imaging plate, or a recording of the image on the imaging plate, would have to be physically brought to the viewer. Many imaging systems now record images electronically, rather than by exposing an imaging plate. The imaging systems may be coupled to a digital imaging and archiving system so that the digital images recorded by the imaging systems may be transmitted electronically to remote locations for viewing. A radiological image viewing system is used at the remote location to convert the digital data into a viewable image.

To purchase a radiological viewing station, a customer may contact a supplier of radiological viewing stations to request information regarding the supplier's radiological viewing stations. Alternatively, a radiological viewing station supplier may contact a customer in hopes of generating sales of radiological viewing stations. Both parties in each of these cases may consume significant amounts of time attempting to elicit basic information from the other. For example, it may take a supplier a significant amount of time simply to establish the customer's basic radiological viewing station needs or desires. Additionally, a customer may expend significant amounts of time obtaining basic information about the radiological viewing station available from the supplier. Indeed, the customer may consume time receiving information from a supplier about radiological viewing station that are simply not suited for the customer's needs or desires.

There is a need, therefore, for an improved technique for providing a radiological image viewer customer with purchasing information regarding a suppliers radiological image viewers prior to contact between a sales representative of the supplier and the customer. There is a particular need for a system or method that provides a customer with information for a recommended radiological image viewers in response to a customer query designed to provide the supplier with some basic information about the customer's needs for a radiological image viewer.

### SUMMARY OF THE INVENTION

According to one aspect of the present invention, a system is featured to enable a radiological image viewer supplier to provide a customer with a recommended radiological image viewer. The system has an application server that directs a query page to the customer via a network. The query page provides the customer with a plurality of questions. The plurality of questions are designed to enable the system to determine a recommended radiological image viewer for the customer based on the customer's responses to the questions. The system also has a comparison program. The comparison program receives a completed query page from the customer and compares the customer's responses in the completed query page to information stored in the computer system to determine the recommended radiological image viewer. The system also has a server to provide a results page to the customer via the network. The results page provides the customer with a recommended radiological image viewer.

According to another aspect of the present invention, a computer system is featured that enables a customer to select a radiological image viewer from among a plurality of radiological image viewers. The computer system has an application server that is coupled to a network. The application server directs a customer to files stored in the computer system. One file stored in the computer system is a product selector file written in a markup language. The product selector file holds a plurality of questions that are designed to obtain data from a customer so as to determine a radiological image viewer to recommend to the customer. Also, the product selector file provides the plurality of questions to a query page for delivery to a customer. The computer system also has a program that operates to determine a recommended radiological image viewer for the customer by comparing data provided by the customer via the plurality of questions to radiological image viewer data stored in the computer system. Another file stored in the computer system is a product configuration file written in a markup language. The product configuration file holds the radiological image viewer data used by the program. The product configuration file provides the recommended radiological image viewer to a results page for delivery to the customer.

According to another aspect of the present invention, a method is featured for utilizing a computer system to assist a customer to configure a radiological image viewer. The method comprises the act of routing a request for assistance from a customer to a product selector file written in extensible markup language (XML). The product selector file fills a template with questions stored in the product selector file. The method also comprises the acts of delivering the template over the network to a customer and receiving the completed template from the customer. The method also comprises the act of determining a recommended radiological image viewer configuration by comparing customer data derived from the completed template to supplier data stored in the computer system in a product configuration file. The product configuration file is also written in XML. The product configuration file fills a results page with the recommended radiological image viewer configuration for delivery to the customer over the network.

### BRIEF DESCRIPTION OF THE DRAWINGS

FIG. 1 is a diagrammatical representation of a picture archiving and communication system or PACS for receiving and storing image data in accordance with certain aspects of the present technique;

FIG. 2 is a diagrammatical representation of contents of a database for referencing stored image data in files containing multiple image data sets, compressed data, and descriptive information;

FIG. 3 is a representation of a typical image of the type received, compressed, and stored on the system of FIG. 1;

FIG. 4 is a diagrammatical representation of a computer system to enable a radiological image viewer supplier to provide a customer with a recommendation for a radiological image viewer;

FIG. 5 is a flowchart for a process whereby a radiological image viewer supplier may provide a customer with a recommendation for a radiological image viewer;

FIG. 6 is a representation of a page for a radiological image viewer supplier, the page having a link to a radiological image viewer product selector;

FIG. 7 is a representation of a query page for a radiological image viewer product selector;

FIG. 8 is a representation of a help page for a radiological image viewer product selector;

FIG. 9 is a representation of a results page featuring a recommended radiological image viewer; and

FIG. 10 is a representation of a results page when the system cannot provide a recommended radiological image viewer and directing the customer to contact a supplier's representative.

### DETAILED DESCRIPTION OF THE INVENTION

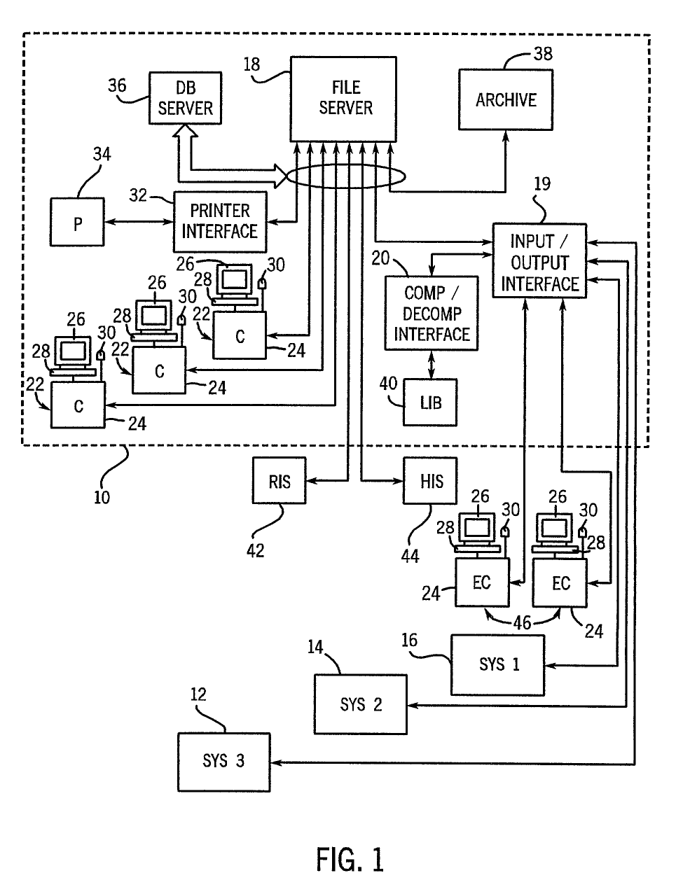

FIG. 1 illustrates a picture archive and communication system or PACS 10 for receiving, compressing and decompressing image data. In the illustrated embodiment, PACS 10 receives image data from several separate imaging systems designated by reference numerals 12, 14 and 16. As will be appreciated by those skilled in the art, the imaging systems may be of various type and modality, such as magnetic resonance imaging (MR) systems, computed tomography (CT) systems, positron emission tomography (PET) systems, radio fluoroscopy (RF), ultrasound systems, and so forth. Moreover, the systems may include computed radiography (CR) systems or other digitizing stations designed to provide digitized image data from existing film or hard copy images. It should also be noted that the systems supplying the image data to the PACS may be located locally with respect to the PACS, such as in the same institution or facility, or may be entirely remote from the PACS, such as in an outlying clinic or affiliated institution. In the latter case, the image data may be transmitted via any suitable network link, including open networks, proprietary networks, virtual private networks, and so forth.

PACS 10 includes one or more file servers 18 designed to receive and process image data, and to make the image data available for decompression and review. Server 18 receives the image data through an input/output interface 19. Image data may be compressed in routines accessed through a compression/decompression interface 20. As described more fully below, interface 20 serves to compress the incoming image data rapidly and optimally, while maintaining descriptive image data available for reference by server 18 and other components of the PACS. Where desired, interface 20 may also serve to decompress image data accessed through the server. The server is also coupled to internal clients, as indicated at reference numeral 22, each client typically including a radiological viewing station 24 at which a radiologist, physician, or clinician may access image data from the server, decompress the image data, and view or output the image data as desired. Client radiological viewing station 24 will typically include a computer monitor 26, a keyboard 28, as well as other input devices 30, such as a mouse. The imaging workstation 24 enables the client to view and manipulate data from a plurality of imaging systems, such as MRI systems, CT systems, PET systems, RF, and ultrasound systems.

Server 18 may be coupled to one or more interfaces, such as a printer interface 32 designed to access and decompress image data, and to output hard copy images via a printer 34 or other peripheral. Server 36 also may associate image data, and other work flow information within the PACS by reference to one or more file servers 18. Database server 36 may include cross-referenced information regarding specific image sequences, referring or diagnosing physician information, patient information, background information, work list cross-references, and so forth. The information within database server 36 serves to facilitate storage and association of the image data files with one another, and to allow requesting clients to rapidly and accurately access image data files stored within the system. Similarly, server 18 is coupled to one or more archives 38, such as an optical storage system, which serve as repositories of large volumes of image data for backup and archiving purposes. Techniques for transferring image data between server 18, and any memory associated with server 18 forming a short term storage system, and archive 38, may follow any suitable data management scheme, such as to archive image data following review and dictation by a radiologist, or after a sufficient time has lapsed since the receipt or review of the image files.

In the illustrated system, other components of the PACS system or institution may be integrated with the foregoing components to further enhance the system functionality. For example, as illustrated in FIG. 1, a compression/decompression library 40 is coupled to interface 20 and serves to store compression routines, algorithms, look up tables, and so forth, for access by interface 20 (or other system components) upon execution of compression and decompression routines (i.e. to store various routines, software versions, code tables, and so forth). In practice, interface 20 may be part of library 40. Library 40 may also be coupled to other components of the system, such as client stations 22 or printer interface 32, serving similarly as a library or store for the compression and decompression routines and algorithms. Although illustrated as a separate component in FIG. 1, it should be understood that library 40 may be included in any suitable server or memory device, including within server 18. Moreover, code defining the compression and decompression processes described below may be loaded directly into interface 20 and/or library 40, or may be loaded or updated via network links, including wide area networks, open networks, and so forth.

Additional systems may be linked to the PACS, such as directly to server 36, or through interfaces such as interface 19. In the embodiment illustrated in FIG. 1, a radiology department information system or RIS 42 is linked to server 18 to facilitate exchanges of data, typically cross-referencing data within database server 36, and a central or departmental information system or database. Similarly, a hospital information system or HIS 44 may be coupled to server 36 to similarly exchange database information, workflow information, and so forth. Where desired, such systems may be interfaced through data exchange software, or may be partially or fully integrated with the PACS system to provide access to data between the PACS database and radiology department or hospital databases, or to provide a single cross-referencing database. Similarly, external clients, as designated at reference numeral 46, may be interfaced with the PACS to enable images to be viewed at remote locations. Each external client also typically utilizes a radiological viewing station 24 at which a radiologist, physician, or clinician may access image data from the server, decompress the image data, and view or output the image data as desired. Such external clients 46 may employ decompression software, or may receive image files already decompressed by interface 20. Again, links to such external clients may be made through any suitable connection, such as wide area networks, virtual private networks, and so forth.

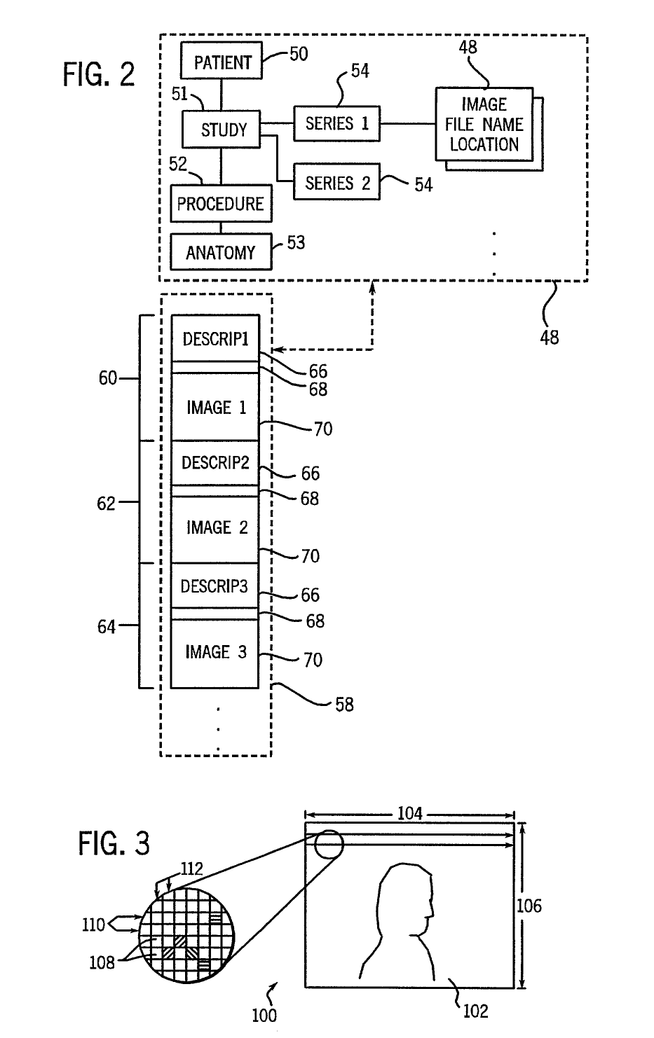

FIG. 2 illustrates in somewhat greater detail the type of cross-referencing data made available to clients through database server 36. The database entries, designated generally by reference numeral 48 in FIG. 2, will include cross-referenced information, including patient data 50, references to specific studies or examinations 51, references to specific procedures performed 52, references to anatomy imaged 53, and further references to specific image series 54 within the study or examination. Such cross-referenced information may include further information regarding the time and date of the examination and series, the name of diagnosing, referring, and other physicians, the hospital or department where the images are created, and so forth. The database will also include address information identifying specific images, file names, and locations of the images as indicated at reference numeral 56. Where the PACS includes various associated memory devices or short term storage systems, these locations may be cross-referenced within the database and may be essentially hidden from the end user, the image files simply being accessed by the system for viewing from the specific storage location based upon cross-referenced information in the database.

FIG. 2 also illustrates an exemplary image file cross-referenced by the database entries. As shown in FIG. 2, image file 58 includes a plurality of image data sets 60, 62 and 64. In a typical image file, a large number of such image sets may be defined by a continuous data stream. Each data set may be compressed in accordance with specific compression algorithms, including lossless compression algorithms as described below, lossy compression algorithms, wavelet algorithms, and the preferred compression code table-based optimal compression algorithm described below.

Within each image data set, a descriptive header 66 is provided, along with a compression header 68. The headers 66 and 68 are followed by compressed image data 70. The descriptive header 66 of each data set preferably includes industry-standard or recognizable descriptive information, such as DICOM compliant descriptive data. Such descriptive information will typically include an identification of the patient, image, date of the study or series, modality of the system creating the image data, as well as additional information regarding specific anatomies or features visible in the reconstructed images.

FIG. 3 illustrates a typical image that is encoded by packets of digitized data assembled in a continuous data stream that may be compressed and decompressed. The image, designated generally by the reference numeral 100, will typically include features of interest 102, such as specific anatomical features. In medical diagnostic applications, such features may include specific anatomies or regions of a patient viewable by virtue of the physics of the image acquisition modality, such as soft tissue in MRI system images, bone in x-ray images, and so forth. Each image is comprised of a matrix having a width 104 and a height 106 defined by the number and distribution of individual pixels 108. The pixels of the image matrix are arranged in rows 110 and columns 112, and will have varying characteristics which, when viewed in the reconstructed image, define the features of interest. In a typical medical diagnostic application, these characteristics will include gray level intensity or color. In the digitized data stream, each pixel is represented by binary code, with the binary code being appended to the descriptive header to aid in identification of the image and in its association with other images of a study. As noted above, such descriptive information may include industry standard information, such as DICOM compliant data.

There are a variety of different radiological image viewers. Additionally, each viewer may be available in a variety of different configurations. Generally, there are standard systems and diagnostic systems. A standard system may offer basic review capabilities for clinicians that need to review studies and reports on a “read only” basis. A diagnostic system may include advanced tools for the diagnostic review of radiological applications and may be intended as a primary review tool for radiologists, specialists and referring physicians.

Additionally, a variety of different monitors are usually available. The monitor is an important component of a radiological image viewer. For example, the resolution of the monitor may be extremely important. Monitors may be available that provide a landscape orientation, as well as a portrait orientation. Monitors are also usually available in color or grayscale.

A customer may utilize a variety of different software packages with a typical radiological image viewer. An example of a software package that may be used with a radiological image viewer is a multi-monitor software package to enable the use of multiple monitors for the display of patient data and studies. Another software package is a Maximum Intensity Projection/Multi-Planar Reconstruction (MIP/MPR) module to reconstruct data from CT and MRI modality operating systems. These are but two of a variety of packages that may be used and is not an exclusive list of software packages that may be selected for operation on a radiological image viewer.

A radiological image viewer may also utilize a film digitizer and/or a data acquisition module. Film digitizers are designed to convert films into high-resolution digital images. A data acquisition module may be required when purchasing a film digitizer. A data acquisition module may be used to capture video data from diagnostic equipment that is not DICOM compliant. The data acquisition module enables this data to be reviewed, forwarded, and stored over the DICOM network.

A radiological image viewer may also utilize an output module. An example of an output module is a DICOM print module to provide enhanced print capabilities for printing radiological images. Another possible output module is a wavelet compression module. A wavelet compression module enables compressed data to be sent over the PACS by the radiological image viewer.

A radiological image viewer may also utilize an archiving module. An archiving module enables storage of patient and study data. The data could be stored in a format such as DICOM. A variety of support, such as a quality control module, training, installation or configuration assistance, may be needed to bring a radiological image viewer into service.

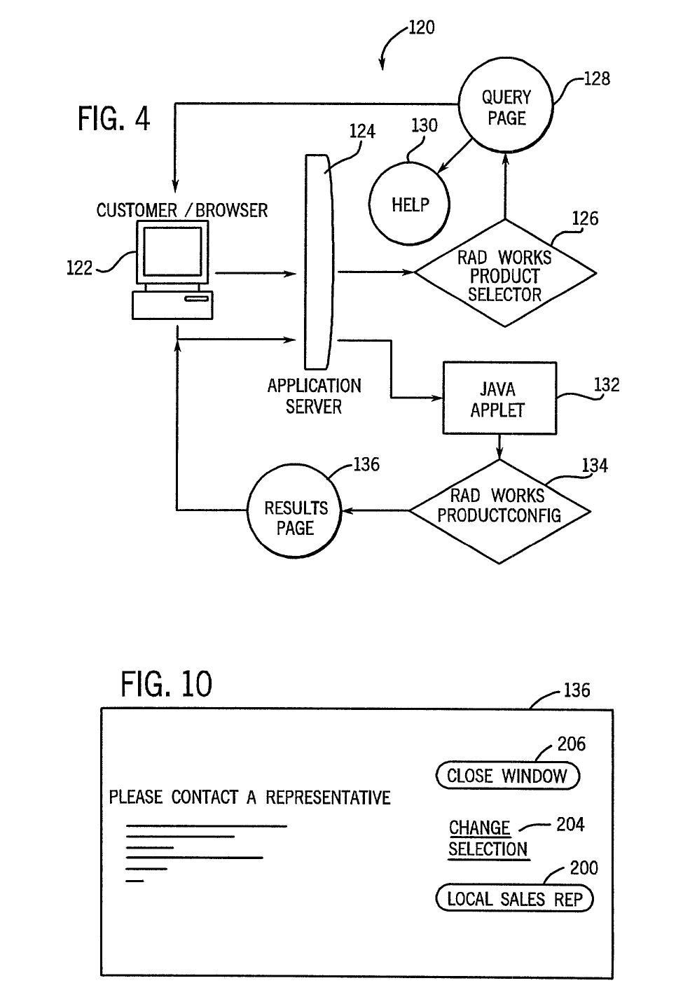

Referring generally to FIG. 4, a system 120 is illustrated that enables a radiological image viewer supplier to provide a customer with a recommended radiological image viewer for the customer's PACS. A radiological image viewer may be selected as a potential recommended radiological image viewer for a variety of reasons. For example, specific configurations of radiological image viewers may be selected to represent recommended radiological image viewers based on the sales history of that specific configuration of radiological image viewers, with the radiological image viewer configurations having the highest sales representing recommended radiological image viewers.

In the illustrated embodiment, a customer may use a computer 122, or other browsing device to access the system 120 over a network, such as the Internet. The system 120 utilizes an application server 124, a “Rad Works” product selector file 126, a query page 128, a help page 130, a Java applet 132, a “Rad Works” product configuration file 134 and a results page 136 to provide a customer with a recommended radiological image viewer. The application server 124 is used to route information around system 120. The application server may comprise a program, such as a Java class. The “Rad Works” product selector file 126 holds the data that is used to populate the query page 128 to be supplied to the customer. The query page 128 contains at least one question designed to tailor the choice of possible radiological image viewers, components or software to meet the needs of the customer. The help page 130 is linked to the query page 128 and contains additional information to assist a customer in answering at least one of the questions.

The Java applet 132 compares the answers in the completed query page 128 to data in the “Rad Works” product configuration file 134. The “Rad Works” product configuration file contains a set of data for a plurality of radiological image viewers that correspond to predicted responses to the questions in the “Rad Works” product selector file. All possible combinations of answers to the plurality of questions may be provided with an associated, or recommended, radiological image viewer. Alternatively, not all of the possible combinations may be provided with a corresponding, or recommended, radiological image viewer. This smaller set of combinations may be based on a number of factors. For example, the product configuration file 134 may be written so that a recommendation is made only for the most commonly sold configurations of radiological image viewers. If the Java applet 132 finds a match between the customer's response and a predicted response, the radiological image viewer information corresponding to the predicted response is provided to the customer via the results page 136. If there is no match, an advisory to contact a sales representative may be provided to the customer.

In the illustrated embodiment, the “Rad Works” product selector file 126 and the “Rad Works” product configuration file 134 are XML files. XML is a method for putting structured data in a text file. XML is powerful because it maintains the separation of the user interface from structured data. HTML specifies how to display data in a browser, but XML defines the content. For example, in HTML tags are used to tell the browser to display data as bold or italic; in XML, style sheets are employed to present the data in a browser. XML separates the data from the presentation and processing, enabling data to be displayed and processed differently by applying different style sheets and applications.

As will be appreciated by those skilled in the art, XML is a meta-markup language that provides a format for describing structured data. This facilitates more precise declarations of content and more meaningful search results across multiple platforms. An unlimited set of tags may be defined in XML. As noted above, while HTML tags may be used to display a word in bold or italic, XML provides a framework for tagging structured data. An XML element can declare its associated data to be a price, a tax, a title, or any other desired data. As XML tags are adopted, there will be a corresponding ability to search for and manipulate data regardless of the applications within which it is found. Once data has been located, it can be delivered over a network and presented in a browser in any number of ways, or it can be handed off to other applications for further processing and viewing.

XML is a subset of the Standard Generalized Markup Language (SGML) that is optimized for delivery over the Web. XML provides a data standard that can encode the content, semantics, and schemata for a wide variety of cases ranging from simple to complex, and which may be used to markup the following: an ordinary document; a structured record, such as an appointment book or purchase order; an object with data and methods, such as the persistent form of a Java object; a data record, such as the result set of a query, meta content of a site; graphical presentations; standard schema entities and types; and all links between entities and types. Once the data is on the client's desktop it can be manipulated, edited, and presented in multiple views, without returning to the server. Servers may then become more scalable, due to lower computational and bandwidth loads. Also, because data is exchanged in the XML format, it can be easily merged from different sources. In the illustrated embodiment, the “Rad Works” product selector file is an XML file. However, “Rad Works” product selector file 126 may be defined by other file or application types, including a different markup language, such as HTML.

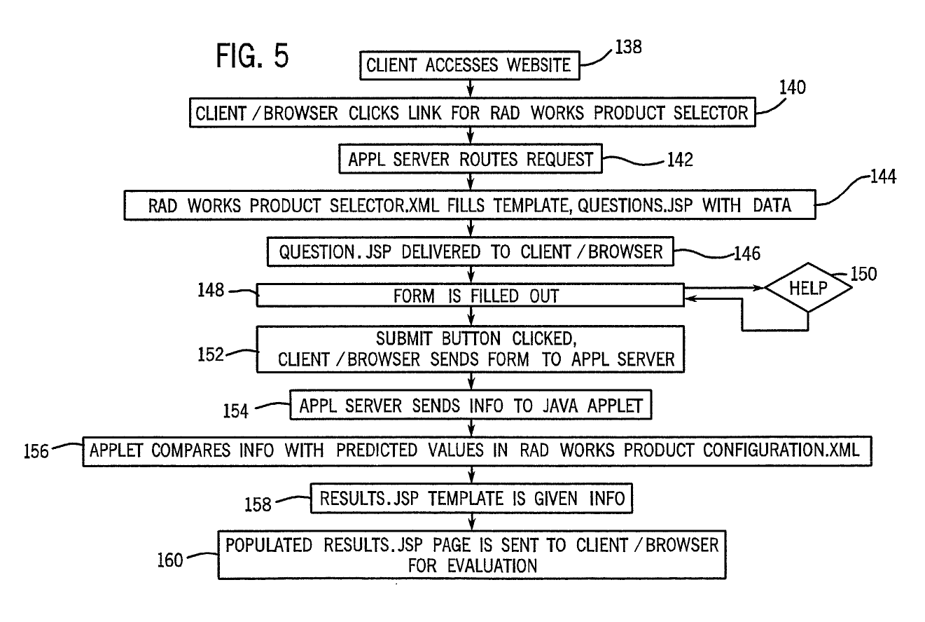

Referring generally to FIG. 5, an exemplary process by which a customer may be provided with information for a recommended radiological image viewer is illustrated. Initially, a customer or client accesses a site, as referenced by step 138. The site may provide a radiological image viewer supplier home page, a radiological image viewer specification page, a product selector page, or some other page of interest to a customer or client interested in purchasing a suppliers radiological image viewers, radiological image viewer components, software, etc. Initially, the client or customer activates a link on the page to enter a radiological image viewer product selector, as referenced by step 140. An application server routes the request to enter the radiological image viewer product selector to a “Rad Works” product selector file, as referenced by step 142. In an exemplary embodiment, the “Rad Works” product selector file is an XML file. The “Rad Works” product selector file contains the data representing the questions to ask a customer to narrow the choice of a radiological image viewer, component, or software to a recommended radiological image viewer, component, or software. The “Rad Works” product selector file fills the query page template with the data, e.g., questions, as referenced by step 144. In an exemplary embodiment, the query page is a Java script file. The query page is sent to the customer browser for completion, as referenced by step 146.

The customer then completes the query page, as referenced by step 148. If a customer would like additional information to help in choosing an answer, the client may activate a link to a help file, as referenced by step 150. When the link is activated, a help page 130 is presented to the customer. In this embodiment, the help page 130 provides additional information specific to each question on the query page. The additional information is designed to assist the customer answer the questions. After obtaining the information, the customer may then return to the query page and continue answering questions. When the customer has completed answering the questions, the completed query page is sent back to the application server by activating a virtual button on the query page, as referenced by step 152.

In the exemplary process, the application server couples the completed query page 128 to a Java applet 132, as referenced by step 154. The Java applet 132 compares the information provided by the customer in their answers to the questions in the query page to predicted responses to the questions contained within the product configuration file 134, as referenced by step 156. If a match is found between the customer's response to the questions and the predicted responses to the questions, the Results page 136 is filled with data describing the recommended radiological image viewer, component, or software, that corresponds to the predicted responses to the questions, as referenced by step 158. The Results page 136 is then provided to the customer for viewing and/or evaluation, as referenced by step 160.

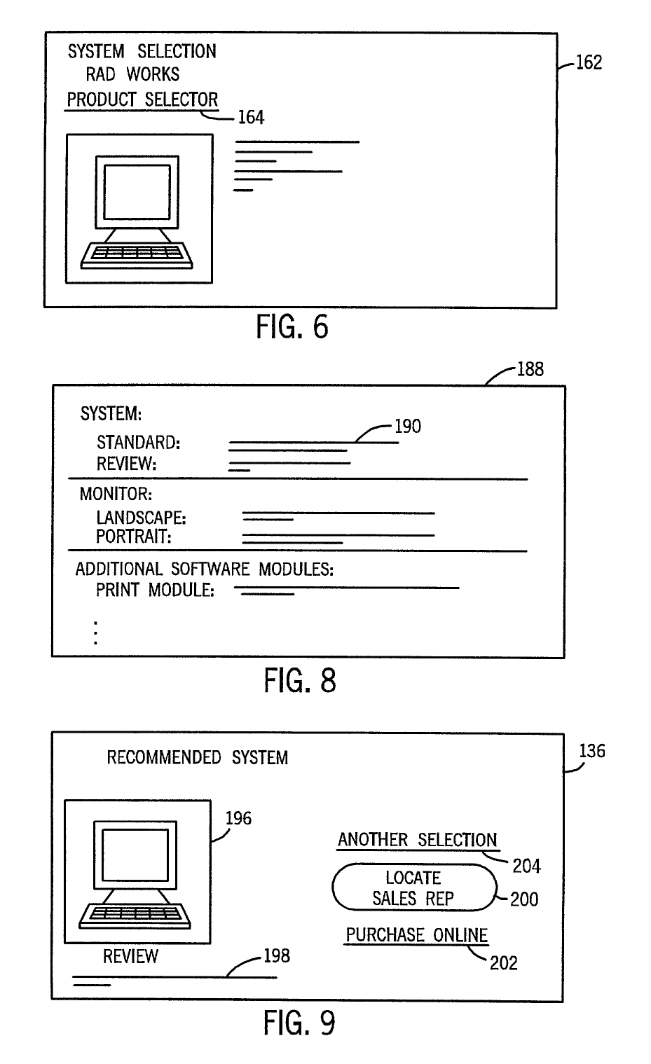

Referring generally to FIG. 6, a page 162 for a radiological image viewer supplier is illustrated. The page 162 may contain information about the supplier's radiological image viewers, components or software. In addition, the page 162 also contains a link 164 to a “Rad Works” product selector.

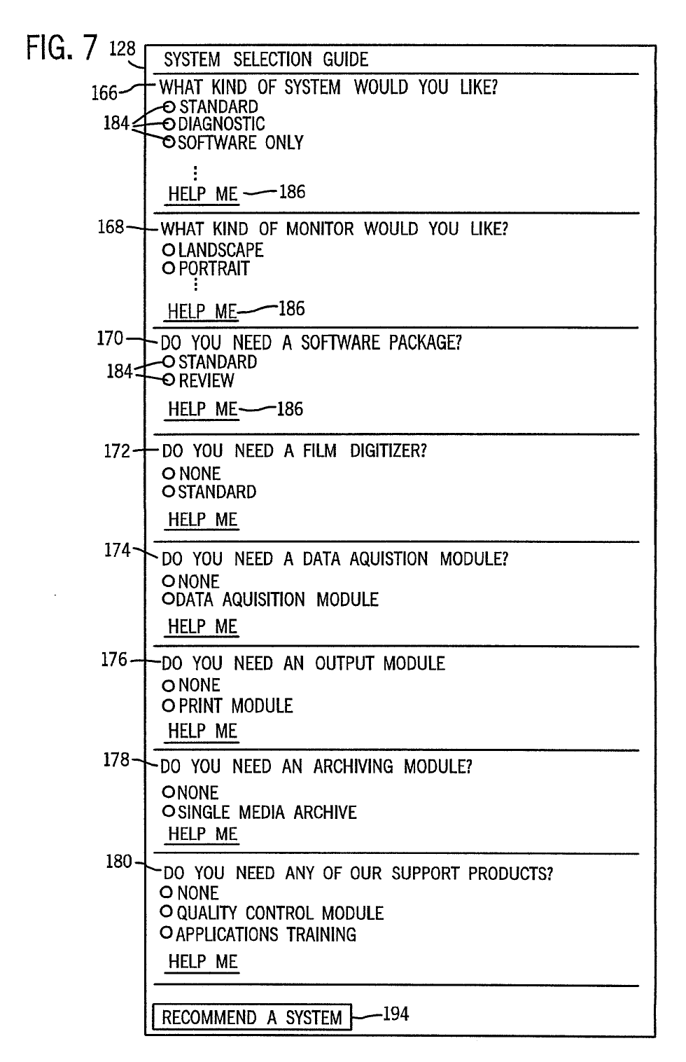

Referring generally to FIG. 7, when the link 164 is activated, system 120 operates to provide the customer browser 122 with a query page 128. In the illustrated embodiment, there are a series of multiple-choice questions 166, 168, 170, 172, 174, 176, 178, and 180 provided to a customer. Each choice is answered by selecting one or more of the choice registers 184. Some questions may have mutually exclusive answers while others may allow multiple answers. The choice registers 184 may be selected by placing the cursor over a choice register 184 and clicking with a mouse button. The series of questions may be designed to elicit all manner of customer information. For example, the questions may be used to determine the single best radiological image viewer, including components and software, according to the needs of each customer. The questions also may be designed to give a supplier an indication of what support, such as training, the customers needs to operate the viewer.

In the illustrated embodiment, the first question 166 asks the customer what kind of radiological image viewer the customer would like: a standard system or a diagnostic system, or if the customer only needs software for a radiological image viewer. The second question 168 asks what type of monitor the customer would like. The third question 170 asks if the customer needs a software package. A customer may choose not to request a software package or a customer may select one or more software packages from among a plurality of software packages. The fourth question 172 asks whether the customer needs a film digitizer and the fifth question 174 asks if the customer needs a data acquisition module. The sixth question 176 asks if the customer needs an output module. The seventh question 178 asks if the customer needs an archiving module. The eighth question 180 asks if the customer needs any support products. The available support products may include items such as training, installation or configuration assistance.

In addition, in this embodiment, each question has a link 186 to the “Help Me” file 130. When the link 186 is activated a small help window 188 is opened, as best illustrated in FIG. 8. In the illustrated embodiment, the link 186 after the first question 166, “What kind of system would you like?” has been activated. The help window 188 provides the text 190 stored in the Help Me file 130 describing the standard system and the diagnostic system. An example of information that may be included in the browser window are the overviews of the standard and diagnostic systems, such as the purposes and features of the systems as well as descriptions of the hardware and software used in each of the respective systems. However, help file 130 may be populated with any type of information that may assist a customer answer any of the other questions provided to the customer. The customer may review the text 190 in help window 188 and decide which system best suits their needs.

Referring again to FIG. 7, when the customer has made their selections, a virtual button 194 may be activated. Activating the virtual button 194 directs the query page to be returned to the system 120 and directs the system 120 to provide the customer with a recommended radiological image viewer, component or software.

Referring generally to FIG. 9, system 120 provides the recommendation for a radiological image viewer, component, or software on a results page 136. The results page 136 provides the customer with a recommended system 196 and recommended options 198. Additionally, results page 136 may have a virtual button 200 that is operable to activate a program to identify a supplier sales representative located near the customer. The results page 136 may also have a purchasing link 202 to initiate a purchasing program to enable a customer purchase a radiological image viewer, component, or software. The results page 136 may also have a link 204 to enable a customer perform another product selection with the “Rad Works” product selector.

As best illustrated in FIG. 10, if there is no radiological image viewer, component, or software that matches the customer's responses to the questions the results page 136 may inform the customer that no radiological image viewer, component, or software may be recommended based on the customers responses to the questions. The customer may be informed to contact a radiological image viewer supplier's sales representative. Therefore, this embodiment of results page 136 also may have a virtual button 200 that is operable to activate a program to identify the nearest supplier's sales representative to the customer. The results page 136 also may have a virtual button 206 to close the browser to close the product selector.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A computer system coupled to a network to enable a radiological viewing station supplier to provide a customer with information relating to a recommended radiological viewing station, the computer system comprising:
an application server to direct a query page to the customer via the network, wherein the query page comprises a plurality of questions designed to enable the computer system to determine a recommended radiological viewing station based on the customer's responses to the plurality of questions, the radiological viewing workstation enabling an operator to view images produced by imaging systems of different modalities, further wherein the query page establishes whether a first radiological viewing station that only has the ability to view radiological images or a second radiological viewing station that has the ability to manipulate radiological images is to be recommended;
a comparison program to receive a completed query page from the customer and compare the customer's responses in the completed query page to a plurality of predicted responses to the plurality of questions, a predicted response corresponding to a radiological viewing station configuration; and
a server to provide a results page to the customer via the network, the results page providing the customer with a recommended radiological viewing station.

2. The system as recited in claim 1, wherein the radiological viewing station enables an operator to view images produced by a computed tomography system.

3. The system as recited in claim 1, wherein the radiological viewing station enables an operator to view images produced by a magnetic resonance imaging system.

4. The system as recited in claim 1, wherein the radiological viewing station enables an operator to view images produced by a positron emission tomography system.

5. The system as recited in claim 1, wherein the radiological viewing station enables an operator to view images produced by a computed radiography CR system.

6. The system as recited in claim 1, wherein the application server comprises a Java class.

7. The system as recited in claim 1, wherein the comparison program comprises a Java applet.

8. The system as recited in claim 1, further comprising a product selector file, wherein the product selector file contains the plurality of questions for supplying the query page.

9. The system as recited in claim 8, wherein the product selector file is written in extensible markup language (XML).

10. The system as recited in claim 1, wherein the query page is written in Java script.

11. The system as recited in claim 1, wherein the query page comprises a link to a help page, wherein the help page provides information to assist a customer answer at least one of the plurality of questions.

12. The system as recited in claim 1, wherein each question has an associated link to a help page, wherein the help page provides information to assist a customer answer each of the plurality of questions.

13. The system as recited in claim 1, wherein the information stored in the computer system is stored in a product configuration file, wherein the product configuration file contains data on specific configurations of radiological viewing stations.

14. The system as recited in claim 13, wherein the specific configurations of radiological viewing stations is determined by a sales history of specific configurations of radiological viewing stations.

15. The system as recited in claim 13, wherein a specific configuration of a radiological viewing station comprises software packages.

16. The system as recited in claim 13, wherein the product selector file is written in extensible markup language (XML).

17. The system as recited in claim 13, wherein the product selector file populates the results page with a specific radiological viewing station configuration that matches the customer's responses in the completed query page.

18. The system as recited in claim 1, wherein the results page is written in Java script.

19. A computer system coupled to a network to assist a customer to select a radiological viewing station from among a plurality of radiological viewing stations, the computer system comprising:
an application server coupled to a network, the application server directing a customer to files stored in the computer system;
a product selector file written in a markup language and stored in the computer system, the product selector file defining a plurality of questions designed to elicit data from a customer to determine a single radiological viewing station to recommend to the customer from among a plurality of radiological viewing stations, wherein the product selector file provides the plurality of questions to a query page for delivery to a customer;
a program that operates to determine a recommended radiological viewing station for the customer by comparing data provided by the customer via the plurality of questions to radiological viewing station data stored in the computer system; and
a product configuration file written in a markup language and stored in the computer system, the product configuration file holding the radiological viewing station data used by the program, wherein the product configuration file provides information relating to a recommended radiological viewing station to a results page for delivery to the customer.

20. The system as recited in claim 19, wherein the product selector file is written in extensible markup language (XML).

21. The system as recited in claim 19, wherein the product configuration file is written in extensible markup language (XML).

22. The system as recited in claim 19, wherein each question is a multiple-choice question.

23. The system as recited in claim 22, further comprising a help file written in a markup language and containing information regarding each choice in at least one multiple-choice question.

24. The system as recited in claim 23, wherein the help file is written in hypertext markup language (HTML).

25. The system as recited in claim 19, wherein the application server is a Java class.

26. The system as recited in claim 19, wherein the program is a Java applet.

27. The system as recited in claim 19, wherein the query page is written in a Java script language.

28. The system as recited in claim 19, wherein the results page is written in a Java script language.

29. The system as recited in claim 29, wherein a recommended computer system comprises software.

30. A method of utilizing a computer system coupled to a network to assist a customer to configure a radiological viewing station from among a plurality of radiological viewing stations, components and software, the method comprising the acts of:
routing a request for assistance from a customer to a product selector file written in extensible markup language (XML), wherein the product selector file fills a template with questions stored in the product selector file;
delivering the template over the network to a customer;
receiving a completed template from the customer; and
determining a recommended radiological viewing station configuration by comparing customer data derived from the completed template to supplier data stored in the computer system in a product configuration file written in XML, wherein the product configuration file fills a results page with the recommended radiological viewing station configuration for delivery to the customer over the network.

31. The method as recited in claim 30, wherein routing comprises activating a link in a page to an application server.

32. The method as recited in claim 31, wherein the application server routes the request to the product selector file.

33. The method as recited in claim 30, wherein the template is a Java script file.

34. The method as recited in claim 30, wherein the results page is a Java script file.

35. A method of utilizing a computer system to configure a recommended radiological viewing station from among a plurality of radiological viewing stations, components and software, the method comprising the acts of:
connecting a customer communication system to a computer system provided by a radiological viewing station supplier;
routing a request for assistance from the customer to a product selector file written in extensible markup language (XML), wherein the product selector file fills a template with questions stored in the product selector file;
delivering the template to a customer;
completing the template with the customer communication system and transmitting it to the computer system;
receiving a completed template from the customer; and
determining a recommended radiological viewing station and configuration by comparing customer data derived from the completed template to supplier data stored in the computer system in a product configuration file written in XML, wherein the product configuration file fills a results page with the recommended radiological viewing station configuration for delivery to the customer communication system.

36. The method as recited in claim 35, wherein the customer communication system is a second computer system having an interface coupled to the Internet.

37. The method as recited in claim 36, wherein the supplier data comprises data for a plurality of radiological viewing station configurations of components and software.

38. The method as recited in claim 37, wherein determining comprises using a program to compare the customer data to the plurality of radiological viewing station configurations of components and software.

39. The method as recited in claim as recited in claim 38, wherein the product configuration file provides the results page with the data for a specific radiological viewing station configuration of components and software when the program identifies a specific radiological viewing station configuration that matches the customer data.
